(19) United States
(12) Patent Application Publication
(10) Pub. No.: US 2022/0261698 A1
(43) Pub. Date: Aug. 18, 2022

(54) INFORMATION PROCESSING DEVICE, NON-TRANSITORY STORAGE MEDIUM, AND INFORMATION PROCESSING METHOD FOR MANAGING VEHICLES THAT ARE USED IN CAR SHARING SERVICE

(71) Applicant: TOYOTA JIDOSHA KABUSHIKI KAISHA, Toyota-shi (JP)

(72) Inventors: Yuka TAKIGUCHI, Toyota-shi (JP); Tetsushi OKAMOTO, Miyoshi-shi (JP); Hirokazu KOBAYASHI, Toyota-shi (JP); Minoru NAKADORI, Toyota-shi (JP); Daiki KANEICHI, Tokyo (JP)

(73) Assignee: TOYOTA JIDOSHA KABUSHIKI KAISHA, Toyota-shi (JP)

(21) Appl. No.: 17/565,603

(22) Filed: Dec. 30, 2021

(30) Foreign Application Priority Data
Feb. 17, 2021 (JP) 2021-023696

(51) Int. Cl. G06Q 10/02

(52) U.S. Cl. CPC G06Q 10/02

(57) ABSTRACT

An information processing device manages vehicles used for a car sharing service. A control unit of the information processing device acquires information requesting use of the vehicles from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area. The control unit manages a usage schedule of the vehicles by the same number of reservation tables as the number of vehicles. For the on-demand use, the control unit determines which reservation table is to be linked to a vehicle among the vehicles parked in the on-demand waiting area, when a request for the on-demand use is accepted.

### CROSS-REFERENCE TO RELATED APPLICATION

This application claims priority to Japanese Patent Application No. 2021-023696 filed on Feb. 17, 2021, incorporated herein by reference in its entirety.

### BACKGROUND

### 1. Technical Field

The present disclosure relates to information processing devices, non-transitory storage media, and information processing methods for managing vehicles that are used for a car sharing service.

### 2. Description of Related Art

As car sharing services are becoming more widespread, various techniques for managing vehicles that are used for the car sharing services have been studied.

For example, Japanese Unexamined Patent Application Publication No. 2017-102553 (JP 2017-102553 A) discloses a vehicle management system capable of rationally sharing vehicles between a car sharing service and a car rental service by combining vehicle management for the car sharing service and vehicle management for the car rental service.

### SUMMARY

It would be convenient for users who use a car sharing service if they could use the car sharing service in two ways: reservation use in which the user makes an advance reservation to use a shared car, and on-demand use in which the user requests and uses a shared car on the spot.

The present disclosure makes it possible to facilitate both reservation use and on-demand use in car sharing services.

A first aspect of the present disclosure relates to an information processing device that manages vehicles used for a car sharing service. The information processing device includes a control unit. The control unit acquires information requesting use of the vehicles from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area. The control unit manages a usage schedule of the vehicles by the same number of reservation tables as the number of the vehicles. For the on-demand use, the control unit determines which of the reservation tables is to be linked to a vehicle among the vehicles parked in the on-demand waiting area, when the control unit accepts a request for the on-demand use.

A second aspect of the present disclosure relates to a non-transitory storage medium storing instructions that are executable by one or more processors and that cause the one or more processors to perform functions including: acquiring information requesting use of vehicles used for a car sharing service from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area; managing a usage schedule of the vehicles by the same number of reservation tables as the number of the vehicles; and for the on-demand use, determining which of the reservation tables is to be linked to a vehicle among the vehicles parked in the on-demand waiting area, when a request for the on-demand use is accepted.

A third aspect of the present disclosure relates to an information processing method for an information processing device that manages vehicles used for a car sharing service. The information processing method includes: acquiring information requesting use of the vehicles from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area; managing a usage schedule of the vehicles by the same number of reservation tables as the number of the vehicles; and for the on-demand use, determining which of the reservation tables is to be linked to a vehicle among the vehicles parked in the on-demand waiting area, when a request for the on-demand use is accepted.

According to the present disclosure, it is possible to facilitate both reservation use and on-demand use in car sharing services.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a configuration of an information processing system according to an embodiment of the present disclosure;

FIG. 2 is a block diagram showing a configuration of an information processing device according to the embodiment of the present disclosure;

FIG. 3 is a block diagram showing a configuration of a terminal device according to the embodiment of the present disclosure;

FIG. 4 is a block diagram illustrating a configuration of a vehicle according to the embodiment of the present disclosure;

FIG. 5 is a block diagram showing a configuration of a server device according to the embodiment of the present disclosure;

FIG. 6 shows an example of a parking area;

FIG. 7 is a flowchart showing an example of the operation of the information processing system according to the embodiment of the present disclosure for reservation use;

FIG. 8 is a flowchart showing an example of the operation of the information processing system according to the embodiment of the present disclosure for on-demand use;

FIG. 9 shows an example in which available times for reservation use are displayed;

FIG. 10 shows an example of display when a user is performing an input operation for reservation use;

FIG. 11 shows an example in which an available time for on-demand use is displayed;

FIG. 12 shows an example of display when the user is performing an input operation for on-demand use;

FIG. 13 shows an example of reservation tables;

FIG. 14 shows an example in which a new reservation has been added to the reservation table;

FIG. 15 shows an example of reservation tables for a plurality of models;

FIG. 16 shows an example of reservation tables when four users have made a reservation;

FIG. 17 shows an example in which there are two parking areas;

FIG. 18 shows an example of reservation tables when a request for on-demand use has been accepted; and

FIG. 19 shows an example of reservation tables when the reservation table has been linked to a vehicle parked in an on-demand waiting area.

### DETAILED DESCRIPTION OF EMBODIMENTS

Hereinafter, an embodiment of the present disclosure will be described with reference to the drawings.

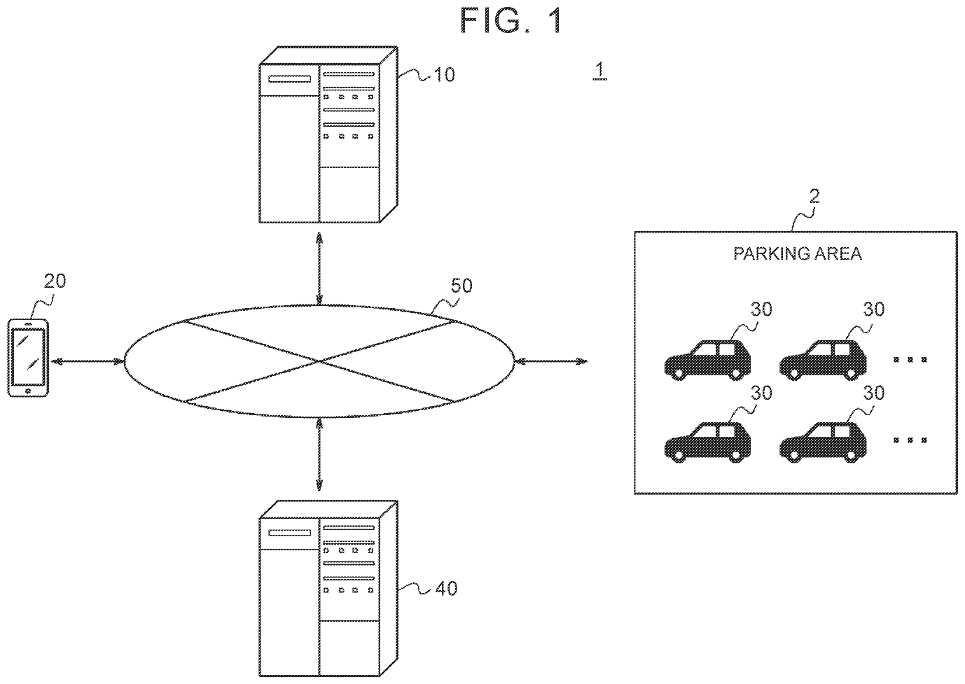

FIG. 1 shows a configuration of an information processing system 1 according to an embodiment of the present disclosure. The configuration and overview of the information processing system 1 according to the embodiment of the present disclosure will be described with reference to FIG. 1.

The information processing system 1 includes an information processing device 10, a terminal device 20, vehicles 30, and a server device 40. The information processing device 10, the terminal device 20, the vehicles 30, and the server device 40 are connected to each other via a network 50 so that they can communicate with each other. The network 50 may be a network including a mobile communication network, the Internet, etc.

Although FIG. 1 shows one information processing device 10, one terminal device 20, and one server device 40, the information processing system 1 may include two or more information processing devices 10, two or more terminal devices 20, and two or more server devices 40.

The vehicles 30 are vehicles that are used for a car sharing service. The vehicles 30 wait in a parking area 2 when they are not being used by a user. The information processing device 10 may manage any number of vehicles 30 for the car sharing service.

The information processing device 10 is, for example, a dedicated computer configured to function as a server. The information processing device 10 may be a general-purpose personal computer (PC).

The information processing device 10 can communicate with the terminal device 20, the vehicles 30, and the server device 40 via the network 50. The information processing device 10 manages the vehicles 30 that are used for the car sharing service.

The terminal device 20 is a terminal device carried by the user who uses the car sharing service. The terminal device 20 may be, for example, a smartphone or a tablet.

The terminal device 20 can communicate with the information processing device 10, the vehicles 30, and the server device 40 via the network 50.

For example, the vehicles 30 are any type of automobiles such as gasoline vehicles, diesel vehicles, hybrid vehicles (HVs), plug-in hybrid vehicles (PHVs), electric vehicles (EVs), or fuel cell vehicles (FCVs). The vehicles 30 are vehicles capable of autonomous driving. The vehicles 30 are vehicles having an automated valet parking (AVP) function. That is, when the user uses the car sharing service, the vehicle 30 can autonomously move to a place where the user gets on the vehicle 30. When the user finishes using the car sharing service and gets off the vehicle 30, the vehicle 30 can autonomously move to a waiting space for the vehicles 30 that are not being used.

The vehicles 30 can communicate with the information processing device 10, the terminal device 20, and the server device 40 via the network 50.

The server device 40 is a dedicated computer configured to function as a server. The server device 40 may be a general-purpose PC.

The server device 40 can communicate with the information processing device 10, the terminal device 20, and the vehicles 30 via the network 50. The server device 40 monitors the status of each vehicle 30 in the parking area 2. The server device 40 sends the status of each vehicle 30 in the parking area 2 to the information processing device 10. For example, the server device 40 may monitor the status of each vehicle 30 in the parking area 2 based on data acquired from a camera, sensor, etc. installed in the parking area 2.

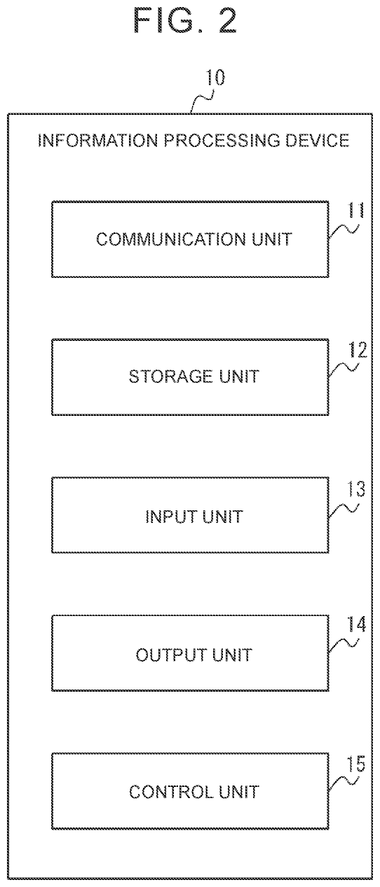

The configuration of the information processing device 10 according to the embodiment of the present disclosure will be described with reference to FIG. 2.

The information processing device 10 includes a communication unit 11, a storage unit 12, an input unit 13, an output unit 14, and a control unit 15.

The communication unit 11 includes a communication module connected to the network 50. For example, the communication unit 11 may include a communication module compatible with a local area network (LAN). In one embodiment, the information processing device 10 is connected to the network 50 via the communication unit 11. The communication unit 11 sends and receives various kinds of information via the network 50. The communication unit 11 can communicate with the terminal device 20, the vehicles 30, and the server device 40 via the network 50.

For example, the storage unit 12 is, but not limited to, a semiconductor memory, a magnetic memory, or an optical memory. The storage unit 12 may function as, for example, a main storage device, an auxiliary storage device, or a cache memory. The storage unit 12 stores any information to be used for the operation of the information processing device 10. For example, the storage unit 12 may store a system program, an application program, and various kinds of information received by the communication unit 11. The information stored in the storage unit 12 may be updatable with, for example, information received from the network 50 via the communication unit 11. A part of the storage unit 12 may be installed outside the information processing device 10. In that case, the part of the storage unit 12 installed outside the information processing device 10 may be connected to the information processing device 10 via a desired interface.

The input unit 13 includes one or more input interfaces that detect user input and acquire input information based on the user's operation. For example, the input unit 13 includes, but not limited to, a physical key, a capacitive key, a touch screen integrated with a display of the output unit 14, or a microphone that accepts voice input.

The output unit 14 includes one or more output interfaces that output information to notify the user. For example, the output unit 14 includes, but not limited to, a display that outputs information as images or a speaker that outputs information as audio.

The control unit 15 includes at least one processor, at least one dedicated circuit, or a combination thereof. The processor is a general-purpose processor such as central processing unit (CPU) or graphics processing unit (GPU), or a dedicated processor specialized for a specific process. The dedicated circuit is, for example, a field-programmable gate array (FPGA) or an application-specific integrated circuit (ASIC). The control unit 15 performs processes related to the operation of the information processing device 10 while controlling various units of the information processing device 10.

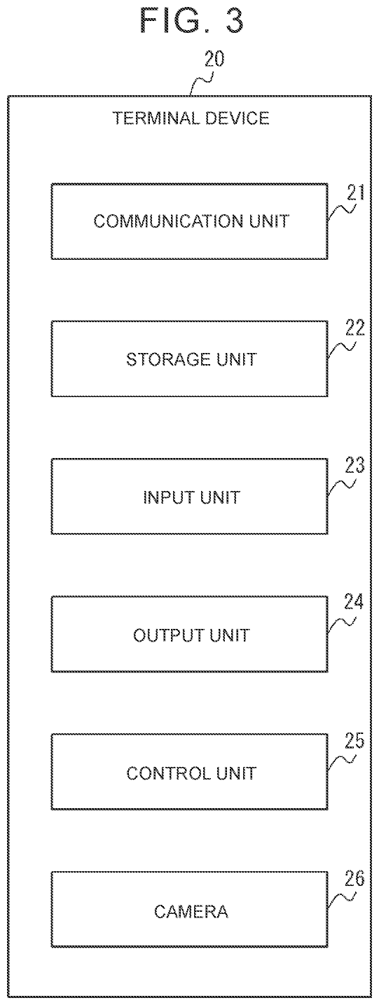

The configuration of the terminal device 20 according to the embodiment of the present disclosure will be described with reference to FIG. 3.

The terminal device 20 includes a communication unit 21, a storage unit 22, an input unit 23, an output unit 24, a control unit 25, and a camera 26.

The communication unit 21 includes a communication module connected to the network 50. For example, the communication unit 21 may include a communication module compatible with mobile communication standards such as Long-Term Evolution (LTE), 4th generation (4G), and 5th generation (5G). In one embodiment, the terminal device 20 is connected to the network 50 via the communication unit 21. The communication unit 21 sends and receives various kinds of information via the network 50. The communication unit 21 can communicate with the information processing device 10, the vehicles 30, and the server device 40 via the network 50.

For example, the storage unit 22 is, but not limited to, a semiconductor memory, a magnetic memory, or an optical memory. The storage unit 22 may function as, for example, a main storage device, an auxiliary storage device, or a cache memory. The storage unit 22 stores any information to be used for the operation of the terminal device 20. For example, the storage unit 22 may store a system program, an application program, and various kinds of information received by the communication unit 21. The information stored in the storage unit 22 may be updatable with, for example, information received from the network 50 via the communication unit 21. A part of the storage unit 22 may be installed outside the terminal device 20. In that case, the part of the storage unit 22 installed outside the terminal device 20 may be connected to the terminal device 20 via a desired interface.

The input unit 23 includes one or more input interfaces that detect user input and acquire input information based on the user's operation. For example, the input unit 23 includes, but not limited to, a physical key, a capacitive key, a touch screen integrated with a display of the output unit 24, or a microphone that accepts voice input.

The output unit 24 includes one or more output interfaces that output information to notify the user. For example, the output unit 24 includes, but not limited to, a display that outputs information as images or a speaker that outputs information as audio.

The control unit 25 includes at least one processor, at least one dedicated circuit, or a combination thereof. The processor is a general-purpose processor such as CPU or GPU, or a dedicated processor specialized for a specific process. For example, the dedicated circuit is an FPGA or an ASIC. The control unit 25 performs processes related to the operation of the terminal device 20 while controlling each unit of the terminal device 20.

The camera 26 is a camera capable of capturing images.

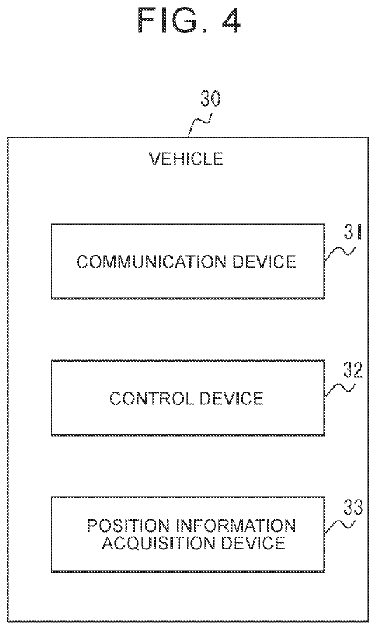

The configuration of the vehicle 30 according to the embodiment of the present disclosure will be described with reference to FIG. 4.

The vehicle 30 includes a communication device 31, a control device 32, and a position information acquisition device 33. The communication device 31, the control device 32, and the position information acquisition device 33 are connected to each other via, for example, an in-vehicle network such as Controller Area Network (CAN) or a dedicated line so that they can communicate with each other.

The communication device 31 includes a communication module connected to the network 50. For example, the communication device 31 may include a communication module compatible with mobile communication standards such as LTE, 4G, and 5G. In one embodiment, the vehicle 30 is connected to the network 50 via the communication device 31. The communication device 31 sends and receives various kinds of information via the network 50. The communication device 31 can communicate with the information processing device 10, the terminal device 20, and the server device 40 via the network 50.

The control device 32 includes at least one processor, at least one dedicated circuit, or a combination thereof. The processor is a general-purpose processor such as CPU or GPU, or a dedicated processor specialized for a specific process. For example, the dedicated circuit is an FPGA or an ASIC. The control device 32 performs processes related to the operation of the vehicle 30 while controlling each unit of the vehicle 30.

The position information acquisition device 33 includes one or more receivers compatible with a desired satellite positioning system. For example, the position information acquisition device 33 may include a Global Positioning System (GPS) receiver. The position information acquisition device 33 acquires a measured value of the position of the vehicle 30 as position information. The position information includes, for example, an address, latitude, longitude, and altitude.

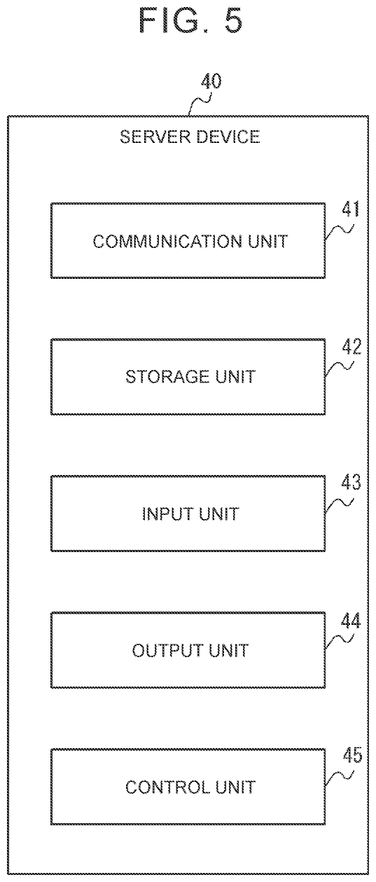

The configuration of the server device 40 according to the embodiment of the present disclosure will be described with reference to FIG. 5.

The server device 40 includes a communication unit 41, a storage unit 42, an input unit 43, an output unit 44, and a control unit 45.

The communication unit 41 includes a communication module connected to the network 50. For example, the communication unit 41 may include a communication module compatible with a LAN. In one embodiment, the server device 40 is connected to the network 50 via the communication unit 41. The communication unit 41 sends and receives various kinds of information via the network 50. The communication unit 41 can communicate with the information processing device 10, the terminal device 20, and the vehicles 30 via the network 50.

For example, the storage unit 42 is, but not limited to, a semiconductor memory, a magnetic memory, or an optical memory. The storage unit 42 may function as, for example, a main storage device, an auxiliary storage device, or a cache memory. The storage unit 42 stores any information to be used for the operation of the server device 40. For example, the storage unit 42 may store a system program, an application program, and various kinds of information received by the communication unit 41. The information stored in the storage unit 42 may be updatable with, for example, information received from the network 50 via the communication unit 41. A part of the storage unit 42 may be installed outside the server device 40. In this case, the part of the storage unit 42 installed outside the server device 40 may be connected to the server device 40 via a desired interface.

The input unit 43 includes one or more input interfaces that detect user input and acquire input information based on the user's operation. For example, the input unit 43 includes, but not limited to, a physical key, a capacitive key, a touch screen integrated with a display of the output unit 44, or a microphone that accepts voice input.

The output unit 44 includes one or more output interfaces that output information to notify the user. For example, the output unit 44 includes, but is not limited to, a display that outputs information as images or a speaker that outputs information as audio.

The control unit 45 includes at least one processor, at least one dedicated circuit, or a combination thereof. The processor is a general-purpose processor such as CPU or GPU, or a dedicated processor specialized for a specific process. The dedicated circuit is, for example, an FPGA or an ASIC. The control unit 45 performs processes related to the operation of the server device 40 while controlling each unit of the server device 40.

### Operation of Information Processing System

The operation of the information processing system 1 shown in FIG. 1 will be described.

First, an overview of the car sharing service that is provided by the information processing system 1 will be described.

The vehicles 30 are vehicles that are used for the car sharing service. The vehicles 30 wait in the parking area 2 when they are not being used by the user. Although FIG. 1 shows one parking area 2, there may be a plurality of parking areas 2. When there is a plurality of parking areas 2, the vehicles 30 not being used by the user may wait in each parking area 2.

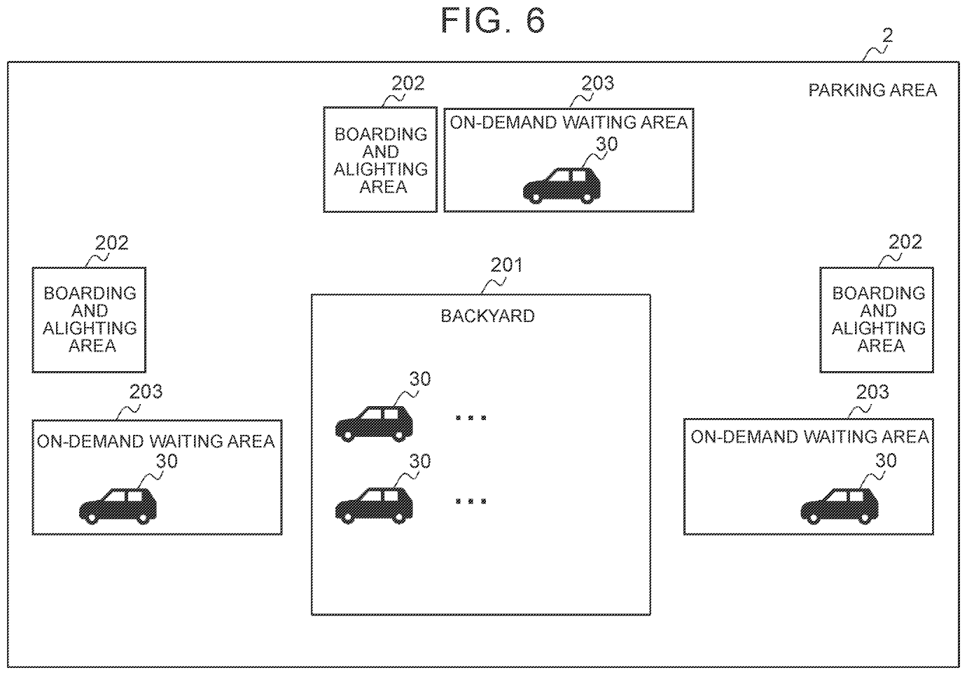

FIG. 6 shows an example of the parking area 2. The parking area 2 is a space where the vehicles 30 not being used by the user can wait. The parking area 2 may be, for example, a space provided in the basement of an apartment building in which the user of the car sharing service etc. lives.

The parking area 2 includes a backyard 201, boarding and alighting areas 202, and on-demand waiting areas 203.

The arrangement of the backyard 201, the boarding and alighting areas 202, and the on-demand waiting areas 203 shown in FIG. 6 is by way of example. The backyard 201, the boarding and alighting areas 202, and the on-demand waiting areas 203 may be provided in the parking area 2 in an arrangement other than the arrangement shown in FIG. 6.

In the example shown in FIG. 6, the parking area 2 has one backyard 201. However, the parking area 2 may have two or more backyards 201. In the example shown in FIG. 6, the parking area 2 has three boarding and alighting areas 202. However, the number of boarding and alighting areas 202 may be two or less or may be four or more. In the example shown in FIG. 6, the parking area 2 has three on-demand waiting areas 203. However, the number of on-demand waiting areas 203 may be two or less or may be four or more.

The backyard 201 is a space where the vehicles 30 not being used by the user wait. A charger capable of charging the battery of the vehicle 30 is installed in the backyard 201. The battery of the vehicle 30 can be charged in the backyard 201 after the user finished using the vehicle 30.

The vehicle 30 can be cleaned in the backyard 201. A machine capable of automatically cleaning the vehicle 30 may be installed in the backyard 201. A space where a worker can clean the vehicle 30 may be provided in the backyard 201.

The boarding and alighting area 202 is a space the user can use to get on and off the vehicle 30. When the user starts using the car sharing service, the user can get on the vehicle 30 in the boarding and alighting area 202. When the user finishes using the car sharing service, the user can get off the vehicle 30 in the boarding and alighting area 202.

The on-demand waiting area 203 is a space where the vehicles 30 available for on-demand use wait. On-demand use will be described later. When using the car sharing service for on-demand use, the user gets on the vehicle 30 parked in the on-demand waiting area 203.

The information processing device 10 manages the vehicles 30 that are used for the car sharing service. The information processing device 10 may manage the vehicles 30 of a plurality of models. For example, when there are 10 vehicles 30 of model A, ten vehicles 30 of model B, and ten vehicles 30 of model C, the information processing device 10 manages the ten vehicles 30 of model A, the ten vehicles 30 of model B, and the ten vehicle 30 of model C. By managing the vehicles 30 of the plurality of models, the information processing device 10 can provide the user with the vehicle 30 that matches the user's purpose.

The information processing device 10 acquires request information for the use of the vehicle 30 from the user. When using the car sharing service, the user uses the terminal device 20 to send request information for the use of the vehicle 30 to the information processing device 10.

In the car sharing service provided by the information processing system 1, the vehicles 30 can be used for both reservation use and on-demand use. The information processing device 10 acquires the request information for the use of the vehicle 30 from the user as either request information for reservation use or request information for on-demand use.

Reservation use is the type of use in which the user makes an advance reservation to use the vehicle 30. For reservation use, the user operates the terminal device 20 to send request information for reservation use to the information processing device 10.

The request information for reservation use that is sent by the user to the information processing device 10 includes information on a desired model, boarding date and time, scheduled return date and time, and desired boarding location. That is, for reservation use, the user can designate the model of the vehicle 30 he or she wants to use. For reservation use, the user can also designate the period of use of the vehicle 30 by the boarding date and time and the scheduled return date and time. For reservation use, the user can also designate the boarding location where the user wants to get on the vehicle 30.

The user can designate any location such as the boarding and alighting area 202 in the parking area 2 or in front of the user's residence as the boarding location. For reservation use, the information processing device 10 dispatches the vehicle 30 assigned to the reservation use so that the vehicle 30 of the model desired by the user will arrive at the boarding location designated by the user at least a predetermined time before the boarding date and time. The vehicle 30 is a vehicle capable of autonomous driving. The vehicle 30 autonomously heads for the boarding location designated by the user in response to a command received from the information processing device 10.

As described above, for reservation use, the user can reliably use the vehicle 30 of the desired model during the scheduled period of use. For reservation use, the user can also get on the vehicle 30 at the desired boarding location. Accordingly, for example, when the user makes planned use of the vehicle 30 for a family trip, distant business trip, etc., reservation use is highly convenient for the user.

On-demand use is the type of use in which the user requests the vehicle 30 parked in the on-demand waiting area 203 and uses the vehicle 30 immediately.

For on-demand use, the user goes to the on-demand waiting area 203, and when there is any vehicle 30 parked in the on-demand waiting area 203, the user requests the vehicle 30 parked in the on-demand waiting area 203. For on-demand use, the user operates the terminal device 20 to send request information for on-demand use to the information processing device 10.

A two-dimensional code including information necessary to request on-demand use is attached to the vehicle 30. For on-demand use, the user uses the camera 26 of the terminal device 20 to take a picture of the two-dimensional code attached to the vehicle 30 parked in the on-demand waiting area 203. The control unit 25 of the terminal device 20 sends information included in the two-dimensional code to the information processing device 10 via the communication unit 21. The two-dimensional code may include, for example, identification information identifying the vehicle 30.

The request information for on-demand use that is sent by the user to the information processing device 10 includes information on scheduled return date and time. Unlike the request information for reservation use, the request information for on-demand use does not include information on a desired model, boarding date and time, and desired boarding location. One reason for this is that, for on-demand use, the user uses the vehicle 30 parked in the on-demand waiting area 203 and therefore cannot choose the model and the boarding location. Another reason for this is that, for on-demand use, the user starts using the vehicle 30 immediately and therefore information on boarding date and time is not necessary.

The control unit 15 of the information processing device 10 may control dispatching of the vehicles 30 so that only the vehicles 30 available for a minimum guaranteed service time or more are parked in the on-demand waiting area 203. As used herein, the minimum guaranteed service time is the minimum guaranteed time for which the user can use the vehicle 30 for on-demand use. The minimum guaranteed service time may be, for example, 1.5 hours. Providing the minimum guaranteed service time as described above ensures that the user can use the vehicle 30 parked in the on-demand waiting area 203 for at least 1.5 hours for on-demand use.

As described above, for on-demand use, when there is any vehicle 30 parked in the on-demand waiting area 203, the user can use the vehicle 30 immediately. Accordingly, on-demand use is highly convenient for the user when the user wants to use the vehicle 30 immediately although he or she did not plan to, such as when going shopping or when getting on or off someone in bad weather.

It is not like that a specific vehicle 30 is always used exclusively for a specific type of use, such as some vehicles 30 are always used exclusively for reservation use and the other vehicles 30 are always used exclusively for on-demand use. That is, whether a certain vehicle 30 is used as a vehicle for reservation use or as a vehicle for on-demand use is flexibly determined. In other words, the same vehicle 30 can be used for both reservation use and on-demand use.

Since the vehicles 30 are not exclusively used for one type of use, it is possible to increase the utilization rate of the vehicles 30 that can be used for the car sharing service.

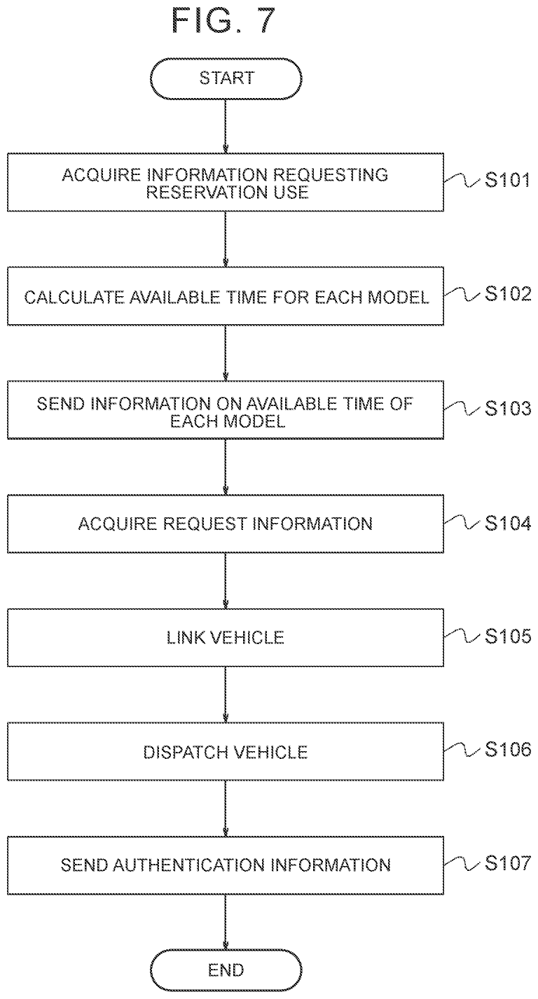

An overview of the operation of the information processing system 1 for reservation use will be described with reference to the flowchart of FIG. 7.

The input unit 23 of the terminal device 20 accepts an input requesting reservation use from the user who desires reservation use. The control unit 25 sends information requesting reservation use to the information processing device 10 via the communication unit 21.

The control unit 15 of the information processing device 10 acquires via the communication unit 11 the information requesting reservation use sent from the terminal device 20 (step S101).

The control unit 15 calculates an available time for each model of the vehicles 30 (step S102). For example, when two models of the vehicles 30, model A and model B, are available for the car sharing service, the control unit 15 calculates an available time of model A and an available time of model B. Each available time calculated by the control unit 15 is the maximum time for which the vehicle 30 is available for reservation use.

The control unit 15 sends information on the available time of each model to the terminal device 20 via the communication unit 11 (step S103).

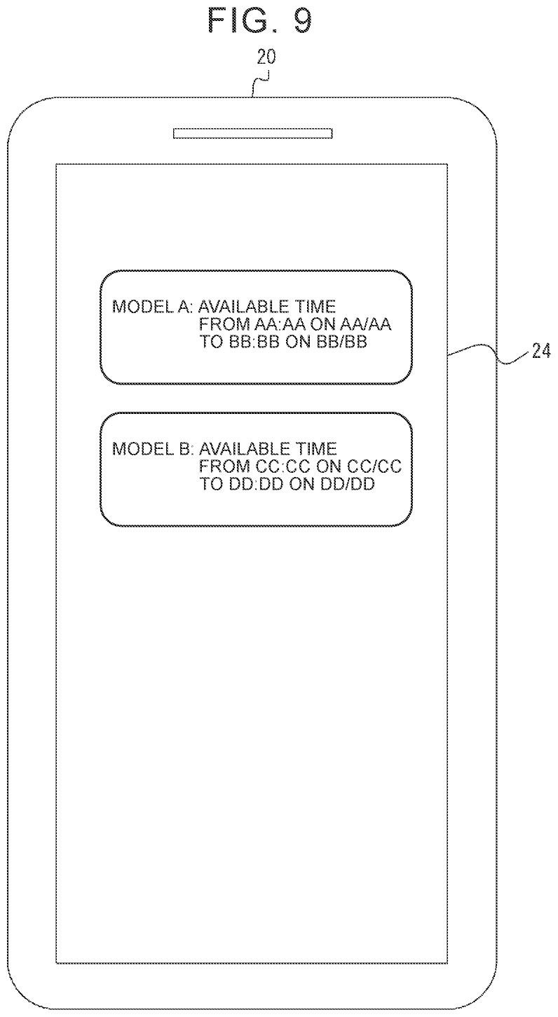

When the control unit 25 of the terminal device 20 acquires the information on the available time of each model, the control unit 25 causes the output unit 24 to display the information on the available time of each model. FIG. 9 shows an example of a screen of the output unit 24 displaying the information on the available time of each model.

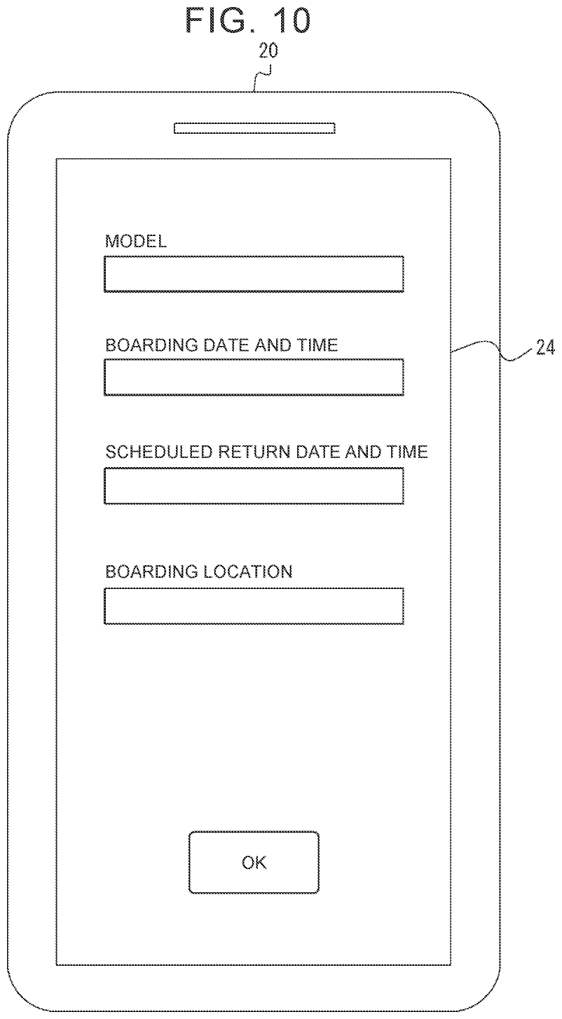

After checking the information on the available time of each model, the user enters request information for reservation use of the vehicle 30 to the input unit 23 of the terminal device 20. FIG. 10 shows an example of a screen of the output unit 24 displayed when the user is entering the request information. As shown in FIG. 10, the user enters information on the model, boarding date and time, scheduled return date and time, and boarding location. The control unit 25 sends the request information entered by the user to the information processing device 10 via the communication unit 21.

The control unit 15 of the information processing device 10 acquires via the communication unit 11 the request information sent from the terminal device 20 (step S104).

The control unit 15 links the vehicle 30 to the acquired request information (step S105). As used herein, linking the vehicle 30 means identifying the vehicle 30 to be used for reservation use based on the acquired request information. Linking of the vehicle 30 will be described in detail later.

The control unit 15 dispatches the vehicle 30 so that the vehicle 30 will arrive at the desired boarding location at least a predetermined time before the boarding date and time (step S106). The predetermined time may be, for example, 10 minutes. For example, when the boarding date and time is 10:00 on January 1st and the predetermined time is 10 minutes, the control unit 15 dispatches the vehicle 30 so that the vehicle 30 will arrive at the desired boarding location by 9:50 on January 1st. When the vehicle 30 receives a dispatch command from the control unit 15, the vehicle 30 autonomously heads for the boarding location desired by the user.

The control unit 15 sends authentication information for the user to get on the dispatched vehicle 30 to the terminal device 20 via the communication unit 11 (step S107).

The user can start using the vehicle 30 by going to the desired boarding location on the boarding date and time and performing an authentication process for the vehicle 30 parked at the boarding location using the authentication information acquired by the terminal device 20.

The user who has finished using the vehicle 30 may get off the vehicle 30 at a desired location. For example, the user may get off the vehicle 30 either in the boarding and alighting area 202 of the parking area 2 or at other location. After the user gets off the vehicle 30, the vehicle 30 autonomously returns to the backyard 201 of the parking area 2.

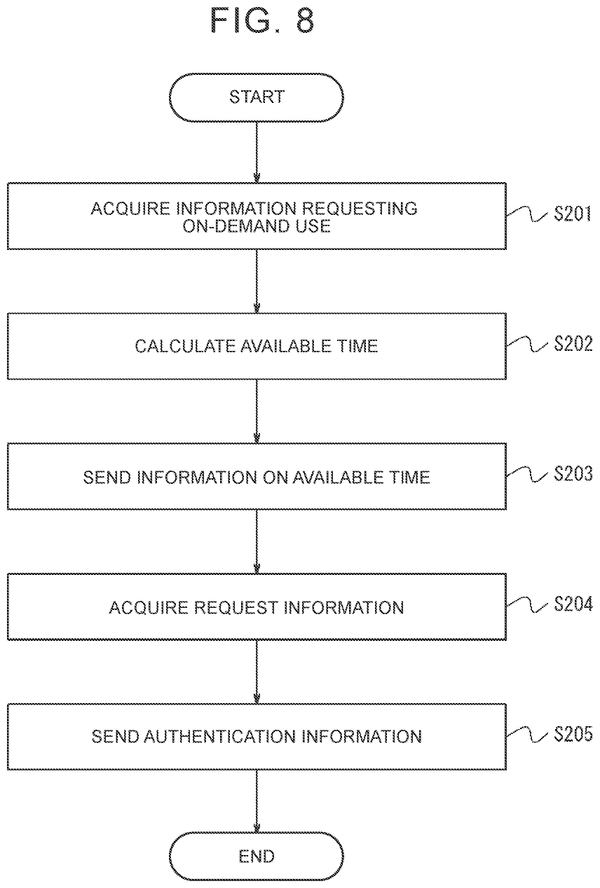

An overview of the operation of the information processing system 1 for on-demand use will be described with reference to the flowchart of FIG. 8.

The user who desires on-demand use goes to the on-demand waiting area 203 of the parking area 2. When there are more than one on-demand waiting area 203, the user may go to any on-demand waiting area 203. For example, the user may go to the on-demand waiting area 203 closest to his or her residence.

A two-dimensional code including information necessary to request on-demand use is attached to the vehicle 30. For on-demand use, the user uses the camera 26 of the terminal device 20 to take a picture of the two-dimensional code attached to the vehicle 30 parked in the on-demand waiting area 203. The control unit 25 of the terminal device 20 sends information included in the two-dimensional code to the information processing device 10 via the communication unit 21. The two-dimensional code may include, for example, identification information identifying the vehicle 30. The control unit 25 sending the information included in the two-dimensional code means that the control unit 25 sends information requesting on-demand use to the information processing device 10 via the communication unit 21.

The control unit 15 of the information processing device 10 acquires via the communication unit 11 the information requesting on-demand use sent from the terminal device 20 (step S201).

The control unit 15 calculates an available time of the vehicle 30 (step S202). The vehicle 30 whose available time is calculated by the control unit 15 is the vehicle 30 a picture of whose two-dimensional code has been taken by the terminal device 20.

The control unit 15 sends information on the calculated available time to the terminal device 20 via the communication unit 11 (step S203).

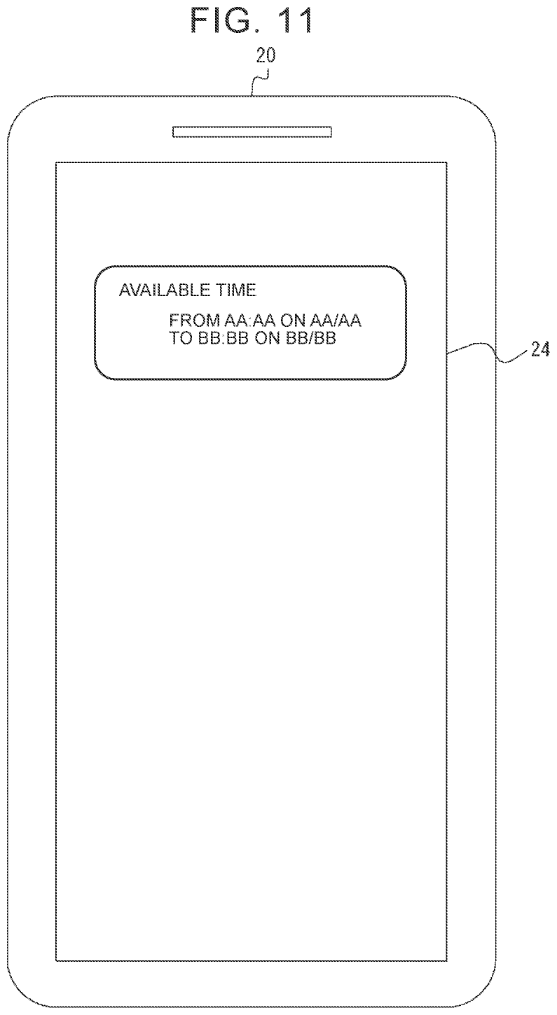

When the control unit 25 of the terminal device 20 acquires the information on the available time of the vehicle 30 parked in the on-demand waiting area 203, the control unit 25 causes the output unit 24 to display the information on the available time. FIG. 11 shows an example of a screen of the output unit 24 displaying the information on the available time of the vehicle 30 parked in the on-demand waiting area 203.

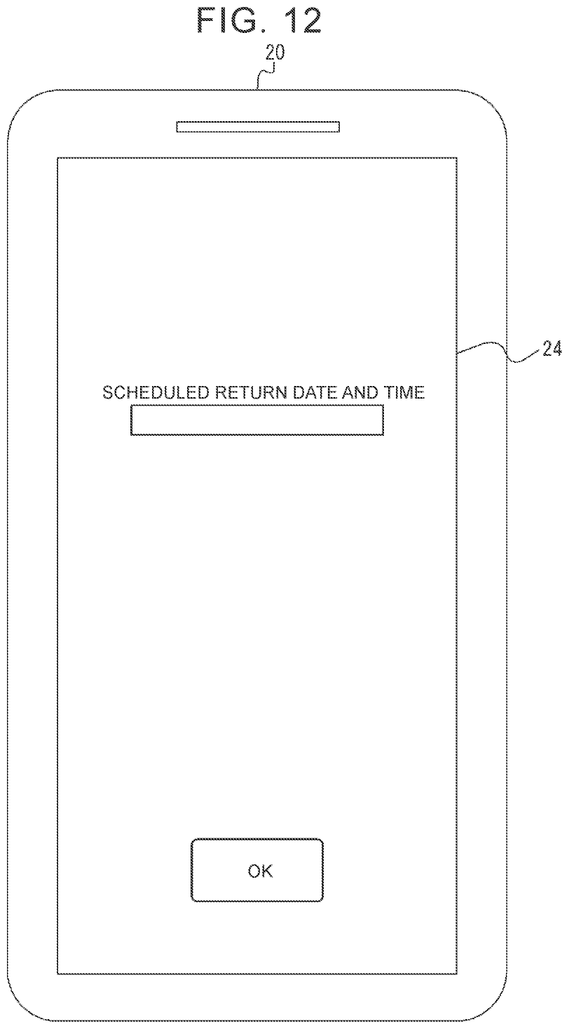

After checking the information on the available time of the vehicle 30 parked in the on-demand waiting area 203, the user enters request information for on-demand use of the vehicle 30 to the input unit 23 of the terminal device 20. FIG. 12 shows an example of a screen of the output unit 24 displayed when the user is entering the request information. As shown in FIG. 12, the user enters information on scheduled return date and time. The control unit 25 sends the request information entered by the user to the information processing device 10 via the communication unit 21.

The control unit 15 of the information processing device 10 acquires via the communication unit 11 the request information sent from the terminal device 20 (step S204).

The control unit 15 sends authentication information for the user to get on the vehicle 30 parked in the on-demand waiting area 203 to the terminal device 20 via the communication unit 11 (step S205).

The user can start using the vehicle 30 by performing an authentication process for the vehicle 30 parked in the on-demand waiting area 203 using the authentication information acquired by the terminal device 20.

The user who has finished using the vehicle 30 may get off the vehicle 30 at a desired location. For example, the user may get off the vehicle 30 either in the boarding and alighting area 202 of the parking area 2 or at other location. After the user gets off the vehicle 30, the vehicle 30 autonomously returns to the backyard 201 of the parking area 2.

### Calculation of Available Times for Reservation Use

The calculation of the available time for each model for reservation use shown in step S102 of the flowchart of FIG. 7 will be described in detail.

The control unit 15 of the information processing device 10 calculates the available time by subtracting a lead time and a downtime from the time available until the next reservation of the vehicle 30.

The lead time is the amount of time set as an estimated time required to dispatch the reserved vehicle 30 to the boarding location desired by the user. The lead time may be, for example, 30 minutes.

The downtime is the amount of time set as a service unavailable time until the vehicle 30 becomes available to the next user after one user uses that vehicle 30. The downtime may be the amount of time set in view of the time required to charge the vehicle 30, the time required to clean the vehicle 30, the time required to inspect the vehicle 30, etc.

Since the time required to charge the vehicle 30, the time required to clean the vehicle 30, etc. vary depending on the model, the downtime may be different for each model. For example, when there are two models, model A and model B, the downtime of model A may be set to three hours, and the downtime of model B may be set to one hour.

The control unit 15 calculates that the available boarding date and time of the vehicle 30 for reservation use, namely the date and time when the vehicle 30 will become available for reservation use, is the lead time from the current time. For example, when the current time is 10:00 on January 1st and the lead time is 30 minutes, the control unit 15 calculates that the available boarding date and time of the vehicle 30 for reservation use is 10:30 on January 1st.

As described above, for reservation use, the available boarding date and time of the vehicle 30 for reservation use is calculated as the lead time from the current time. Accordingly, when the user desires reservation use of the vehicle 30, the time that can be set as the boarding date and time of the vehicle 30 is the lead time from the current time or later.

The control unit 15 may set an upper limit on the available time when calculating the available time for reservation use. The upper limit may be, for example, one week or two weeks. When the available time calculated by subtracting the lead time and the downtime from the time available until the next reservation of the vehicle 30 is longer than the upper limit of the available time, the control unit 15 may set the available time to the value of the upper limit of the available time.

The control unit 15 calculates the available time for each model. When there is more than one available vehicle 30 of the same model, the control unit 15 calculates the available time of each of those available vehicles 30 and selects the longest one of the calculated available times as the available time of that model.

The control unit 15 sends information on the calculated available time of each model to the terminal device 20 via the communication unit 11.

### Calculation of Available Time for On-Demand Use

The calculation of the available time for on-demand use shown in step S202 of the flowchart of FIG. 8 will be described in detail.

The control unit 15 of the information processing device 10 calculates the available time by subtracting the downtime from the time available until the next reservation of the vehicle 30.

The control unit 15 calculates that the available boarding date and time of the vehicle 30 for on-demand use, namely the date and time when the vehicle 30 will become available for on-demand use, is the current time. For example, when the current time is 10:00 on January 1st, the control unit 15 calculates that the available boarding date and time of the vehicle 30 for on-demand use is 10:00 on January 1st.

As described above, for on-demand use, the available boarding date and time of the vehicle 30 for on-demand use is calculated as the current time. Accordingly, for on-demand use, the user can immediately use the vehicle 30.

The control unit 15 may set an upper limit on the available time when calculating the available time for on-demand use. The upper limit may be, for example, 12 hours. When the available time calculated by subtracting the downtime from the time available until the next reservation of the vehicle 30 is longer than the upper limit of the available time, the control unit 15 may set the available time to the value of the upper limit of the available time.

As described above, the control unit 15 calculates the available time of the vehicle 30 by different methods depending on whether the available time is for reservation use or for on-demand use.

### Reservation Tables

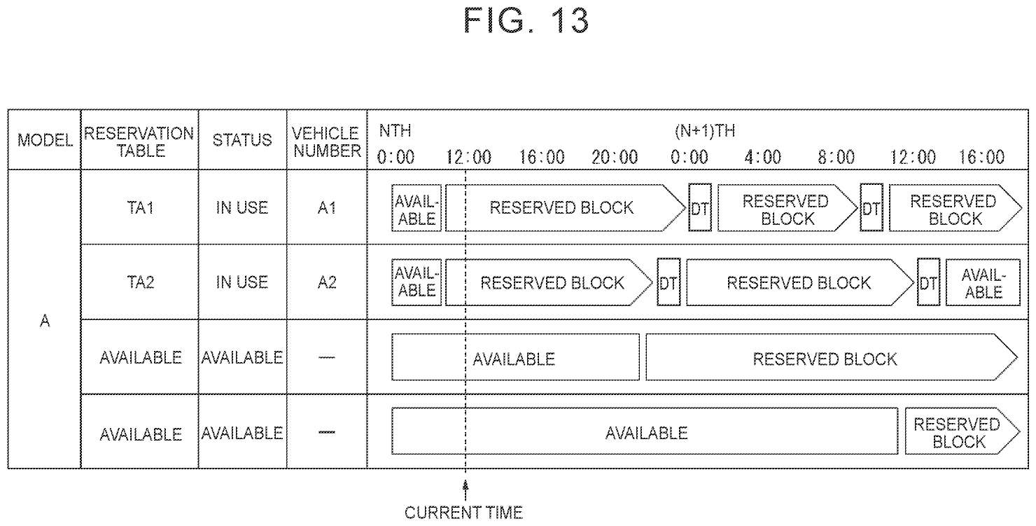

The control unit 15 of the information processing device 10 manages the usage schedule of the vehicles 30 by reservation tables. FIG. 13 shows an example of how the control unit 15 manages the vehicles 30 of model A by the reservation tables.

The number of reservation tables is the same as the number of vehicles 30 that are used for the car sharing service. The number of reservation tables for each model is the same as the number of vehicles 30 of that model.

For example, when there are ten vehicles 30 of model A, ten vehicles 30 of model B, and ten vehicles of model C, the number of reservation tables for model A is ten, the number of reservation tables for model B is ten, and the number of reservation tables for model C is ten.

When the number of vehicles 30 available for the car sharing service has decreased due to regular service etc., the control unit 15 also reduces the number of reservation tables accordingly. For example, when the number of available vehicles 30 of model A has decreased from ten to nine due to regular service, the control unit 15 reduces the number of reservation tables for model A from ten to nine.

No reservation table is exclusively linked to a specific vehicle 30. That is, which vehicle 30 will use the usage schedule being managed by a certain reservation table is determined flexibly.

For reservation use, the control unit 15 determines a predetermined time before the start time of reservation use which vehicle 30 is to be linked to the reservation table. The predetermined time may be, for example, 30 minutes.

For on-demand use, the control unit 15 determines in response to a request for on-demand use which vehicle 30 is to be linked to the reservation table.

FIG. 13 shows an example in which there are four vehicles 30 of model A and the control unit 15 manages these vehicles 30 of model A by four reservation tables TA1 to TA4. The reservation table includes information on the status, vehicle number, and schedule.

The status indicates whether the reservation table is “in use” or “available” at the current time. In the example shown in FIG. 13, the status of the reservation tables TA1 and TA2 is “in use” because the schedule at the current time is “reserved block.” Each slot marked with “reserved block” in the schedule means that a reservation has already been made for that period of time.

In the example shown in FIG. 13, the status of the reservation tables TA3 and TA4 is “available” because the schedule at the current time is “available.” Each slot marked with “available” in the schedule means that no reservation has been made for that period of time.

The vehicle number indicates the vehicle 30 currently linked to the reservation table. In the example shown in FIG. 13, the vehicle 30 with a vehicle number “A1” is currently linked to the reservation table TA1. This means that the vehicle 30 identified by the vehicle number “A1” is being used for the reservation from 11:00 on the Nth to 0:00 on the (N+1)th in the reservation table TA1. The vehicle 30 with a vehicle number “A2” is currently linked to the reservation table TA2.

In the example shown in FIG. 13, the “vehicle number” boxes in the reservation tables TA3 and TA4 are blank. This means that no specific vehicles 30 are currently linked to the reservation tables TA3 and TA4.

In the example shown in FIG. 13, slots in the schedule are marked with “available,” “reserved block,” and “DT.” Each slot marked with “available” means that no reservation has been made for that period of time. Each slot marked with “reserved block” means that a reservation has already been made for that period of time. Each slot marked with “DT” means the downtime. Each slot marked with “reserved block” may be the total of the lead time and the amount of time reserved by the user.

It is herein assumed that information requesting reservation use has been acquired from the user. In the example shown in FIG. 13, the status of the reservation tables TA3 and TA4 is currently “available,” but the available time in the reservation table TA4 is longer than that in the reservation table TA3. Accordingly, the control unit 15 sends the available time calculated for the reservation table TA4 to the terminal device 20 via the communication unit 11.

In the example shown in FIG. 13, since the current time is 12:00 on the Nth, the control unit 15 calculates that the start date and time of the available time is 12:30 on the Nth, namely the lead time after 12:00 on the Nth. It is herein assumed that the lead time is 30 minutes.

In the example shown in FIG. 13, the reservation table TA4 has a reservation from 12:00 on the (N+1)th. In this case, the control unit 15 calculates that the end date and time of the available time is 11:00 on the (N+1)th, namely the downtime before 12:00 on the (N+1)th. It is herein assumed that the downtime is one hour.

In this way, the control unit 15 calculates that the available time of model A for reservation use is from 12:30 on the Nth to 11:00 on the (N+1)th.

It is also assumed that information requesting on-demand use of the vehicle 30 of model A parked in the on-demand waiting area 203 of the parking area 2 has been acquired from the user. In the example shown in FIG. 13, the status of the reservation tables TA3 and TA4 is currently “available,” but the available time in the reservation table TA4 is longer than that in the reservation table TA3. Accordingly, the control unit 15 sends the available time calculated for the reservation table TA4 to the terminal device 20 via the communication unit 11.

For on-demand use, the start date and time of the available time is the current time, namely 12:00 on the Nth.

As in the case of reservation use, the control unit 15 calculates that the end date and time of the available time is 11:00 on the (N+1)th, namely the downtime before 12:00 on the (N+1)th.

In this way, the control unit 15 calculates that the available time for on-demand use is from 12:00 on the Nth to 11:00 on the (N+1)th.

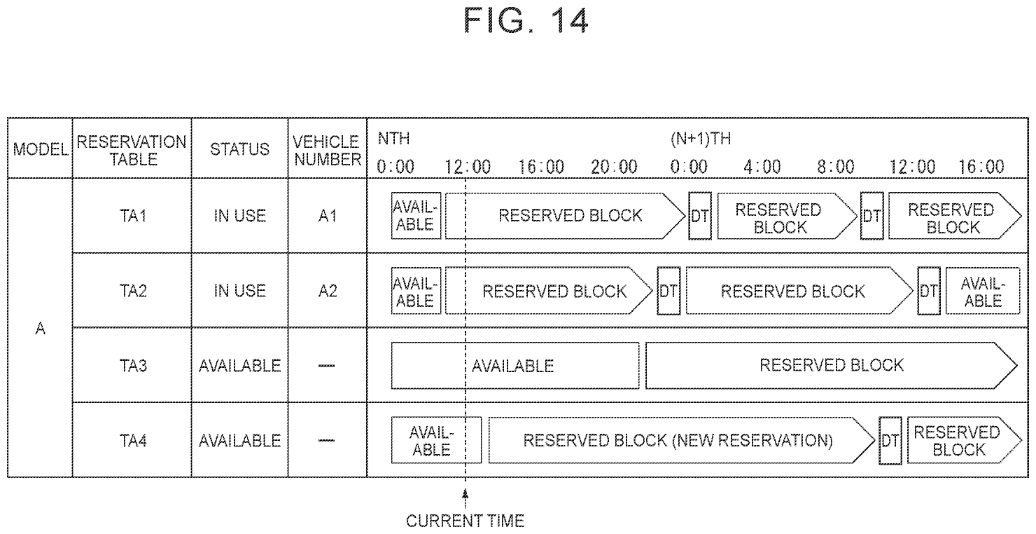

FIG. 14 shows an example in which the control unit 15 has added usage schedule information on a new reservation to the reservation table TA4. In the example shown in FIG. 14, the control unit 15 has added usage schedule information on a new reservation from 13:00 on the Nth to 11:00 on the (N+1)th. The usage schedule information on a new reservation is shown as “reserved block (new reservation)” in FIG. 14. The usage schedule information may be the total of the lead time and the amount of time reserved by the user. The control unit 15 adds the downtime after the usage schedule information on a new reservation. In the example shown in FIG. 14, the control unit 15 has added the downtime from 11:00 to 12:00 on the (N+1)th.

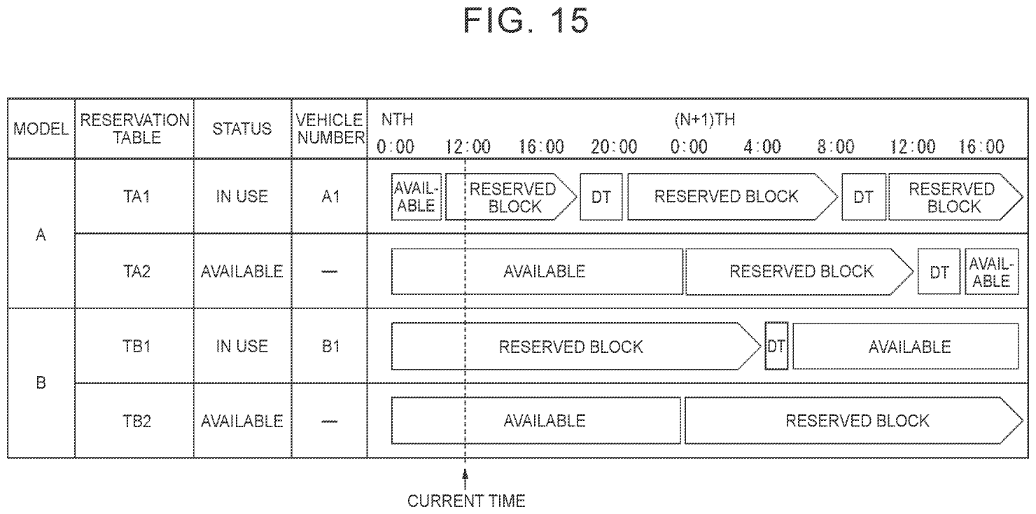

FIG. 15 shows an example of how the control unit 15 manages the vehicles 30 of models A and B by the reservation tables. FIG. 15 shows an example in which there are two vehicles 30 of model A and two vehicles 30 of model B. The control unit 15 manages the vehicles 30 of model A by two reservation tables TA1 and TA2. The control unit 15 also manages the vehicles 30 of model B by two reservation tables TB1 and TB2.

It is herein assumed that information requesting reservation use has been acquired from the user. In the example shown in FIG. 15, the status of the reservation tables TA2 and TB2 is currently “available.” The control unit 15 calculates the available time for model A based on the reservation table TA2. The control unit 15 calculates the available time for model B based on the reservation table TB2.

In the example shown in FIG. 15, the status of both the reservation table TA2 for model A and the reservation table TB2 for model B is “available” from 12:00 on the Nth that is the current time to 0:00 on the (N+1)th. In the example shown in FIG. 15, however, the downtime varies between model A and model B. The downtime for model A is three hours, and the downtime for model B is one hour. Accordingly, the control unit 15 calculates different available times for model A and model B.

Specifically, the control unit 15 calculates that the available time for model A is from 12:30 on the Nth to 21:00 on the Nth. The control unit 15 calculates that the available time for model B is from 12:30 on the Nth to 23:00 on the Nth.

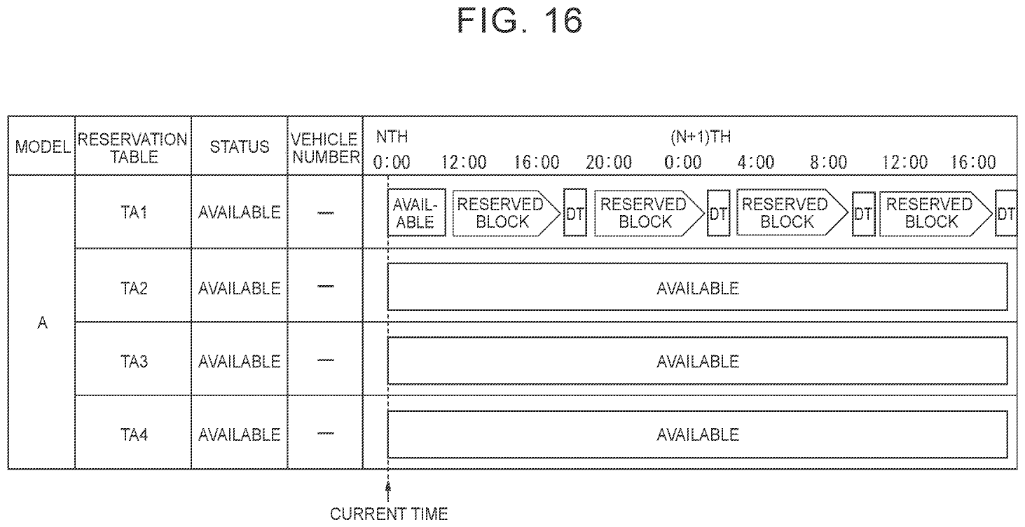

FIG. 16 shows an example of the reservation tables for model A when requests for reservation use have been acquired from four users.

In the example shown in FIG. 16, the control unit 15 has added four pieces of usage schedule information to the reservation table TA1. In this way, the control unit 15 can maximize the utilization rate of the vehicles 30 by adding as many pieces of usage schedule information as possible to one reservation table.

For example, when the four pieces of usage schedule information are dispersedly added to the four reservation tables TA1 to TA4, the fifth user cannot make a long time reservation of model A from the Nth to the (N+1)th. However, when the control unit 15 adds these pieces of usage schedule information to one reservation table as shown in FIG. 16, the fifth user can make a long time reservation of model A from the Nth to the (N+1)th as the status of the reservation tables TA2 to TA4 is “available” from the Nth to the (N+1)th. As a result, the control unit 15 can maximize the utilization rate of the vehicles 30 of model A.

### Linking in Reservation Use

For reservation use, the control unit 15 determines a predetermined time before the start time of reservation use which vehicle 30 is to be linked to the reservation table. The predetermined time may be, for example, 30 minutes. For reservation use, the control unit 15 determines based on a predetermined condition which vehicle 30 is to be preferentially linked to the reservation table.

Hereinafter, the predetermined condition for the control unit 15 to determine which vehicle 30 is to be preferentially linked to the reservation table will be described.

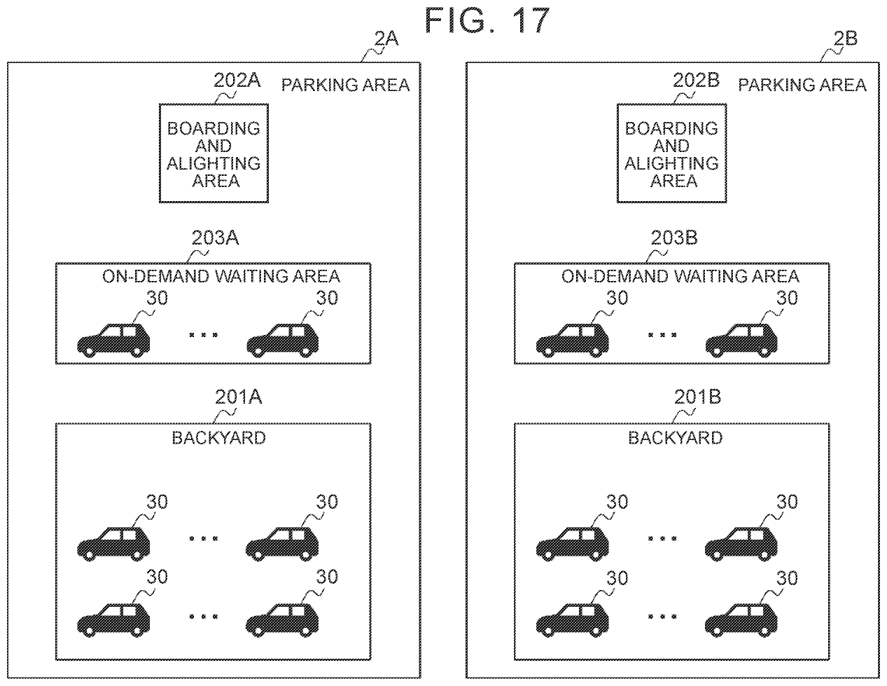

FIG. 17 shows an example in which there are two parking areas 2: a parking area 2A and a parking area 2B. The parking area 2A includes a backyard 201A, a boarding and alighting area 202A, and an on-demand waiting area 203A. The parking area 2B includes a backyard 201B, a boarding and alighting area 202B, and an on-demand waiting area 203B. For example, the parking area 2A and the parking area 2B may be separated from each other by about several hundreds of meters to about several kilometers.

The predetermined condition for the control unit 15 to determine which vehicle 30 is to be preferentially linked to the reservation table will be described with reference to FIG. 17.

When linking a specific vehicle 30 to the reservation table, the control unit 15 determines the order of priority based on the following first to third conditions, and links the vehicle 30 with a high level of priority to the reservation table. In this case, the control unit 15 links the vehicle 30 with a high level of priority to the reservation table out of the vehicles 30 of the model designated by the reservation table. For example, when the model designated by the reservation table is model A, the control unit 15 links the vehicle 30 of model A with a high level of priority to the reservation table out of the vehicles 30 of model A.

### First Condition

The control unit 15 preferentially links the vehicle 30 waiting in the parking area 2 including the boarding location desired by the user to the reservation table over the vehicles 30 waiting in the parking area 2 not including the boarding location desired by the user.

For example, in FIG. 17, it is assumed that the boarding location desired by the user is the boarding and alighting area 202A in the parking area 2A. It is also assumed that the user desires model A. In this case, the control unit 15 preferentially links the vehicle 30 of model A waiting in the parking area 2A to the reservation table over the vehicles 30 of model A waiting in the parking area 2B.

As the control unit 15 links the vehicle 30 waiting in the parking area 2A to the reservation table as described above, wasteful movement of the vehicle 30 can be reduced such as moving the vehicle 30 waiting in the parking area 2B to the boarding and alighting area 202A in the parking area 2A.

### Second Condition

The control unit 15 preferentially links the vehicle 30 waiting in the backyard 201 of the parking area 2 to the reservation table over the vehicles 30 waiting in the on-demand waiting area 203.

For example, in FIG. 17, it is assumed that the user desires model A and the vehicles 30 of model A are waiting in both the backyard 201A and the on-demand waiting area 203A. In this case, the control unit 15 preferentially links the vehicle 30 waiting in the backyard 201A to the reservation table over the vehicles 30 waiting in the on-demand waiting area 203A.

For example, when the vehicle 30 waiting in the on-demand waiting area 203A is linked to the reservation table, the vehicle 30 waiting in the on-demand waiting area 203A moves to the boarding and alighting area 202A before the boarding date and time. In this case, since it is necessary to replenish the on-demand waiting area 203A with another vehicle 30, one of the vehicles 30 waiting in the backyard 201A needs to be moved to an open spot in the on-demand waiting area 203A. As the control unit 15 preferentially links the vehicle 30 waiting in the backyard 201A to the reservation table over the vehicles 30 waiting in the on-demand waiting area 203A, such wasteful movement of the vehicle 30 can be reduced.

### Third Condition

The control unit 15 preferentially links the vehicle 30 with the longest elapsed time since the end of the previous use to the reservation table.

For example, in FIG. 17, it is assumed that the user desires model A and a plurality of vehicles 30 of model A is waiting in the backyard 201A. In this case, the control unit 15 preferentially links the vehicle 30 with the longest elapsed time since the end of the previous use to the reservation table out of the vehicles 30 waiting in the backyard 201A.

As the control unit 15 preferentially links the vehicle 30 with the longest elapsed time since the end of the previous use to the reservation table, the utilization rate can be equalized among the vehicles 30. This configuration makes it possible to reduce a possibility that a specific vehicle 30 is used frequently.

The control unit 15 gives priority to the first condition over the second and third conditions. The control unit 15 gives priority to the second condition over the third condition.

Hereinafter, some cases will be specifically described. It is assumed that the boarding location desired by the user for reservation use is the boarding and alighting area 202A of the parking area 2A and the user desires model A.

Case 1: A plurality of vehicles 30 of model A is waiting in the backyard 201A of the parking area 2A.

In this case, the control unit 15 preferentially links the vehicle 30 with the longest elapsed time since the end of the previous use to the reservation table out of the vehicles 30 of model A waiting in the backyard 201A.

Case 2: There is no vehicle 30 of model A waiting in the backyard 201A of the parking area 2A, and a plurality of vehicles 30 of model A is waiting in the on-demand waiting area 203A of the parking area 2A.

In this case, the control unit 15 preferentially links the vehicle 30 with the longest elapsed time since the end of the previous use to the reservation table out of the vehicles 30 of model A waiting in the on-demand waiting area 203A.

Case 3: There is no vehicle 30 of model A waiting in the parking area 2A, and a plurality of vehicles 30 of model A is waiting in the backyard 201B of the parking area 2B.

In this case, the control unit 15 preferentially links the vehicle 30 with the longest elapsed time since the end of the previous use to the reservation table out of the vehicles 30 of model A waiting in the backyard 201B of the parking area 2B.

Case 4: There is no vehicle 30 of model A waiting in the parking area 2A, there is no vehicle 30 of model A waiting in the backyard 201B of the parking area 2B, and a plurality of vehicles 30 of model A is waiting in the on-demand waiting area 203B of the parking area 2B.

In this case, the control unit 15 preferentially links the vehicle 30 with the longest elapsed time since the end of the previous use to the reservation table out of the vehicles 30 of model A waiting in the on-demand waiting area 203B of the parking area 2B.

### Linking in On-Demand Use

For on-demand use, the control unit 15 determines in response to a request for on-demand use which reservation table is to be linked to the vehicle 30 parked in the on-demand waiting area 203.

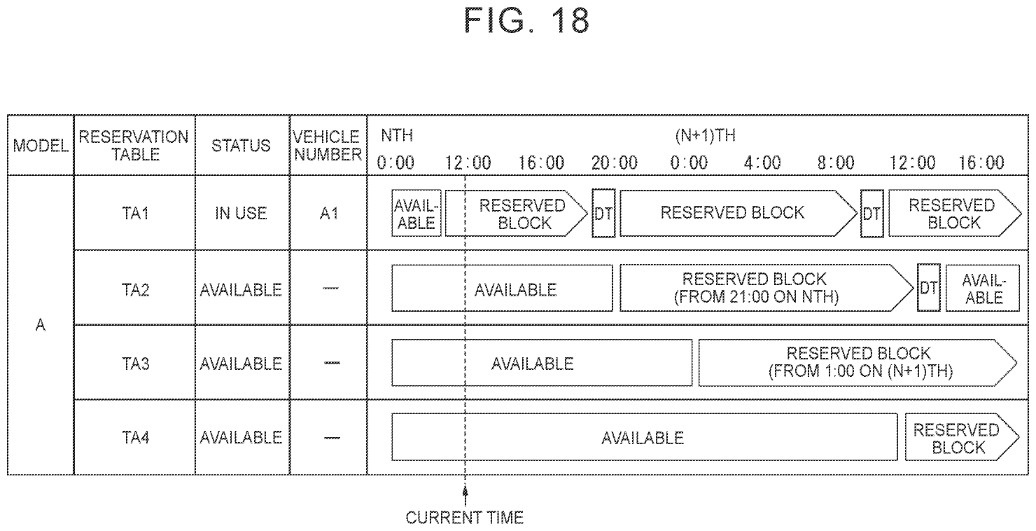

How the control unit 15 determines which reservation table is to be linked to the vehicle 30 parked in the on-demand waiting area 203 will be described with reference to FIG. 18. FIG. 18 shows an example of the reservation tables when a request for on-demand use is accepted from the user.

It is assumed that the user has requested on-demand use of the vehicle 30 of model A parked in the on-demand waiting area 203. FIG. 18 shows the reservation tables for the vehicles 30 of model A at this time. Since there are four vehicles 30 of model A, there are four reservation tables TA1 to TA4. It is assumed that the vehicle number of the vehicle 30 of model A parked in the on-demand waiting area 203 is A2.

The control unit 15 links the reservation table whose status is “available” at the current time to the vehicle 30 parked in the on-demand waiting area 203.

Referring to FIG. 18, the status of the reservation table TA1 is “in use” at the current time, namely at 12:00 on the Nth. The control unit 15 therefore removes the reservation table TA1 from the list of candidate reservation tables to be linked. The status of the reservation tables TA2 to TA4 is “available” at the current time, namely at 12:00 on the Nth. The control unit 15 therefore considers the reservation tables TA2 to TA4 to be candidate reservation tables to be linked.

It is herein assumed that the scheduled return date and time entered to the terminal device 20 by the user who desires on-demand use of the vehicle 30 parked in the on-demand waiting area 203 is 21:00 on the Nth. Assuming that the downtime after on-demand use of the vehicle 30 is one hour, the status of the reservation table needs to be “available” until 22:00 on the Nth.

In this case, since the reservation table TA2 has another reservation from 21:00 on the Nth, the control unit 15 removes the reservation table TA2 from the list of candidate reservation tables to be linked. The reservation tables TA3 and TA4 have no other reservation until 22:00 on the Nth. The control unit 15 therefore considers the reservation tables TA3 and TA4 to be candidate reservation tables to be linked.

When there is a plurality of reservation tables whose status is “available” and that can be considered to be candidate reservation tables to be linked as described above, the control unit 15 links one of the candidate reservation tables to the vehicle 30 parked in the on-demand waiting area 203 so as to maximize the available time of the vehicle 30 of model A for the user who is going to use the vehicle 30 of model A next.

In the example shown in FIG. 18, when the reservation table TA3, for example, is linked to the vehicle 30 parked in the on-demand waiting area 203, the status of the reservation table TA4 remains “available.” In this case, the user who is going to use the vehicle 30 of model A next can use the vehicle 30 of model A until 11:00 on the (N+1)th.

On the other hand, when the reservation table TA4 is linked to the vehicle 30 parked in the on-demand waiting area 203, the status of the reservation table TA3 remains “available.” In this case, the user who is going to use the vehicle 30 of model A next can use the vehicle 30 of model A until 23:00 on the Nth.

As described above, linking the reservation table TA3 to the vehicle 30 parked in the on-demand waiting area 203 can maximize the available time of the vehicle 30 of model A for the user who is going to use the vehicle 30 of model A next. Therefore, in this case, the control unit 15 links the reservation table TA3 to the vehicle 30 parked in the on-demand waiting area 203.

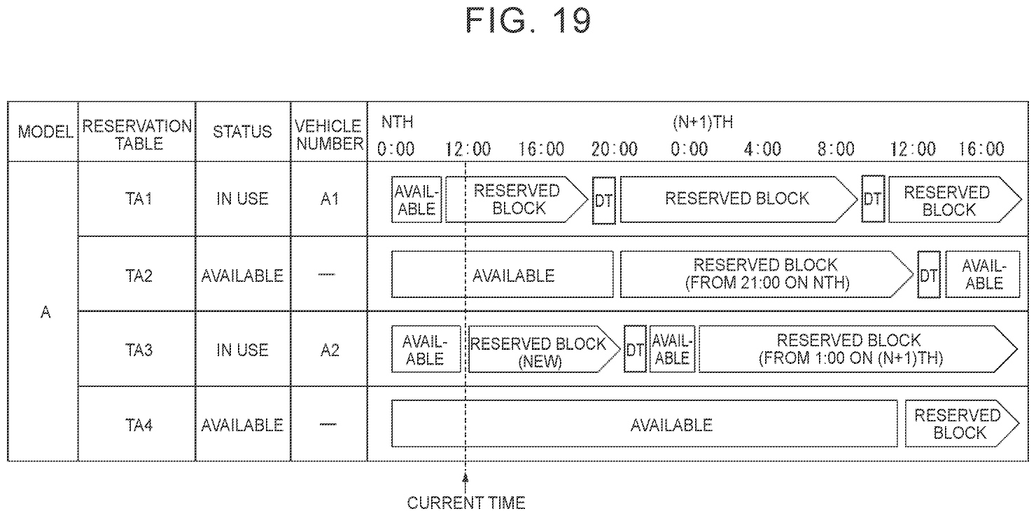

FIG. 19 shows an example in which the control unit 15 has linked the reservation table TA3 to the vehicle 30 parked in the on-demand waiting area 203.

As shown in FIG. 19, the control unit 15 links the reservation table TA3 to the vehicle 30 with vehicle number A2 parked in the on-demand waiting area 203. The control unit 15 can thus maximize the utilization rate of the vehicles 30 of model A.

Double Booking for Reservation Use and On-Demand Use

When the control unit 15 starts accepting a request for on-demand use from the user, the vehicle 30 requested for on-demand use may be excluded from the list of available vehicles 30 for reservation use. This configuration can reduce a possibility that the vehicle 30 parked in the on-demand waiting area 203 from becomes unavailable for on-demand use during processing of a request for on-demand use due to that vehicle 30 being included in the list of available vehicles 30 for reservation use.

As described above, in the information processing device 10 according to the present embodiment, the control unit 15 acquires request information for the use of the vehicle 30 from the user as either request information for reservation use or request information for on-demand use. The control unit 15 manages the usage schedule of the vehicles 30 by the same number of reservation tables as the number of the vehicles 30. For on-demand use, the control unit 15 determines which reservation table is to be linked to the vehicle 30 parked in the on-demand waiting area 203, when the control unit 15 accepts a request for on-demand use. As described above, the information processing device 10 can appropriately manage the vehicles 30 for both reservation use and on-demand use by using the reservation tables. Accordingly, both reservation use and on-demand use can be facilitated by using the information processing device 10 according to the present embodiment for the sharing car service.

The present disclosure is not limited to the above embodiment. For example, a plurality of blocks shown in the block diagram may be integrated into one block, or a block may be divided into a plurality of sub-blocks. Instead of performing a plurality of steps of the flowchart in chronological order according to the description, the steps may be performed in parallel or in a different order either according to the processing capability of the device that performs each step or as necessary. Other modifications can be made without departing from the spirit and scope of the present disclosure.

For example, a part of the processing operation performed by the information processing device 10 in the above embodiment may be performed by the terminal device 20 or the server device 40.

For example, a part of the processing operation performed by the terminal device 20 in the above embodiment may be performed by the information processing device 10 or the server device 40.

For example, a part of the processing operation performed by the server device 40 in the above embodiment may be performed by the information processing device 10 or the terminal device 20.

For example, in the above embodiment, the information processing device 10 and the server device 40 are described as independent devices. However, the information processing device 10 and the server device 40 may be an integrated device.

For example, a general-purpose electronic device such as smartphone or computer may be configured to function as the information processing device 10 according to the above embodiment. Specifically, programs including the processing content for implementing each function of the information processing device 10 etc. of the embodiment are stored in a memory of the electronic device, and the programs are read and executed by a processor of the electronic device. Accordingly, the disclosure according to the embodiment can also be implemented as a program that can be executed by a processor.

Although an example in which a plurality of models of vehicles 30 is available for the car sharing service is described in the above embodiment, the number of models of vehicles 30 may be one.

What is claimed is:

1. An information processing device that manages vehicles used for a car sharing service, the information processing device comprising a control unit, wherein:
the control unit is configured to acquire information requesting use of the vehicles from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area;
the control unit is configured to manage a usage schedule of the vehicles by the same number of reservation tables as the number of the vehicles; and
for the on-demand use, the control unit is configured to determine which of the reservation tables is to be linked to a vehicle among the vehicles parked in the on-demand waiting area, when the control unit accepts a request for the on-demand use.

2. The information processing device according to claim 1, wherein for the on-demand use, the control unit links, to the vehicles parked in the on-demand waiting area, the reservation tables whose statuses indicate that the reservation tables are available at current time.

3. The information processing device according to claim 2, wherein when the statuses of two or more of the reservation tables indicate that the reservation tables are available, the control unit links to the vehicle parked in the on-demand waiting area a reservation table that maximizes an available time of the same model of a vehicle as the vehicle parked in the on-demand waiting area for a next user who is going to use the vehicle of the model.

4. The information processing device according to claim 1, wherein the request information for the on-demand use includes information on a scheduled return date and time.

5. The information processing device according to claim 1, wherein for the on-demand use, the control unit acquires the request information for the on-demand use from a terminal device of the user that has read a two-dimensional code attached to each of the vehicles parked in the on-demand waiting area.

6. The information processing device according to claim 1, wherein the on-demand use has a minimum guaranteed service time.

7. The information processing device according to claim 1, wherein the on-demand use has an upper limit on an available time.

8. A non-transitory storage medium storing instructions that are executable by one or more processors and that cause the one or more processors to perform functions comprising:
acquiring information requesting use of vehicles used for a car sharing service from a user as either request information for reservation use or request information for on-demand use, the request information for reservation use being information requesting reservation use in which the user makes an advance reservation of the vehicles, and the request information for on-demand use being information requesting on-demand use in which the user requests to use the vehicles parked in an on-demand waiting area;
managing a usage schedule of the vehicles by the same number of reservation tables as the number of the vehicles; and
for the on-demand use, determining which of the reservation tables is to be linked to a vehicle among the vehicles parked in the on-demand waiting area, when a request for the on-demand use is accepted.

9. The non-transitory storage medium according to claim 8, wherein the functions further comprise, for the on-demand use, linking, to the vehicles parked in the on-demand waiting area, the reservation tables whose statuses indicate that the reservation tables are available at current time.

10. The non-transitory storage medium according to claim 9, wherein the functions further comprise, when the statuses of two or more of the reservation tables indicate that the reservation tables are available, linking to the vehicle parked in the on-demand waiting area a reservation table that maximizes an available time of the same model of a vehicle as the vehicle parked in the on-demand waiting area for a next user who is going to use the vehicle of the model.

11. The non-transitory storage medium according to claim 8, wherein the request information for the on-demand use includes information on a scheduled return date and time.

12. The non-transitory storage medium according to claim 8, wherein the functions further comprise, for the on-demand use, acquiring the request information for the on-demand use from a terminal device of the user that has read a two-dimensional code attached to each of the vehicles parked in the on-demand waiting area.

13. The non-transitory storage medium according to claim 8, wherein the on-demand use has a minimum guaranteed service time.

14. The non-transitory storage medium according to claim 8, wherein the on-demand use has an upper limit on an available time.

15. An information processing method for an information processing device that manages vehicles used for a car sharing service, the information processing method comprising:
acquiring information requesting use of the vehicles from a user as either request information for reservation use or request information for on-demand use, the request information for reservation use being information requesting reservation use in which the user makes an advance reservation of the vehicles, and the request information for on-demand use being information requesting for on-demand use in which the user requests to use the vehicles parked in an on-demand waiting area;
managing a usage schedule of the vehicles by the same number of reservation tables as the number of the vehicles; and
for the on-demand use, determining which of the reservation tables is to be linked to a vehicle among the vehicles parked in the on-demand waiting area, when a request for the on-demand use is accepted.

16. The information processing method according to claim 15, further comprising for the on-demand use, linking, to the vehicles parked in the on-demand waiting area, the reservation tables whose statuses indicate that the reservation tables are available at current time.

17. The information processing method according to claim 16, further comprising when the statuses of two or more of the reservation tables indicate that the reservation tables are available, linking to the vehicle parked in the on-demand waiting area a reservation table that maximizes an available time of the same model of a vehicle as the vehicle parked in the on-demand waiting area for a next user who is going to use the vehicle of the model.

18. The information processing method according to claim 15, wherein the request information for the on-demand use includes information on a scheduled return date and time.

19. The information processing method according to claim 15, further comprising for the on-demand use, acquiring the request information for the on-demand use from a terminal device of the user that has read a two-dimensional code attached to each of the vehicles parked in the on-demand waiting area.

20. The information processing method according to claim 15, wherein the on-demand use has a minimum guaranteed service time.
